(19) United States
(12) Patent Application Publication
(10) Pub. No.: US 2006/0149612 A1
(43) Pub. Date: Jul. 6, 2006

(54) Customer service reporting system

(76) Inventors: James B. Engle, Green Valley, AZ (US); Andrew G. Hourselt, Tucson, AZ (US); Harish C. Mathur, Tucson, AZ (US)

Correspondence Address: LAW OFFICE OF CHARLES W. PETERSON, JR. TUCSON, 11703 BOWMAN GREEN DR, suite 100, RESTON, VA, 20190, US

(21) Appl. No.: 11/030,375

(22) Filed: Jan. 6, 2005

(51) Int. Cl. G06F 9/46

(52) U.S. Cl. 705/8

(57) ABSTRACT

A product service reporting system, method and program product for reporting product problem resolutions. A service code database contains service code records of previously encountered product problem and associated problem solutions. The service code database is sorted based on service code. Problems and associated problem solutions for specific products are entered in the service code database thorough a service code input interface. Service code records are hierarchically searched by field through a customer service input interface.

### BACKGROUND OF THE INVENTION

1. Field of the Invention

The present invention is related to product support management and more particularly to reporting product problem solutions, e.g., to a customer service organization.

2. Background Description

Corporations maintain customer service organizations to address customer problems with products to insure customer product satisfaction. Typically customers are given a number to call or an e-mail address to contact if they should have questions about or, encounter problems with products. As each problem is reported, it is assigned a problem report reference number for tracking progress towards problem resolution, both by customers and by the customer service organization. Once a problem is reported and a problem record reference number is assigned, one or more Customer Service Representative(s) (CSRs) is/are assigned the responsibility of finding a solution to the particular problem. Once the problem is resolved, the CSR reports the steps or actions to resolve the problem to the customer service organization and the report is logged to close the problem reference number. Many customer service organizations use shorthand type of codes to improve reporting efficiency and reduce valuable CSR time spent reporting problem resolutions.

For example, in the past CSRs have resorted to using hardcopy lists of shorthand codes or acronyms, such as Technical Area Codes (TAC), to encode and decipher problems and resolutions for each particular problem. Typically, the CSR carried hardcopy volumes of these TACs along on a service call and would refer to those volumes when filling out his/her service report. However, because maintaining these lists and continually printing and distributing updated hard copies was costly. Further, with each newly added or deleted code, these volumes were out of date. More recently, the CSR has provided feedback on-line, recorded in a 60-80 character field, e.g., as a Quality Service Activity Report (QSAR). A typical QSAR does not provide much information, much less detailed information on actions the CSR has taken to resolve a given problem. Often several different customers encounter very similar problems or identically described problems may occur repeatedly with the same system, subsystem or subassembly. Unfortunately, QSARs still do not do much to help the CSR describe the subtle variations on resolutions to these similar problems.

With the typically large volume of problem reports it may be impractical to have each CSR report each problem individually. Also, the typical QSAR provides very limited information. So, the same detailed information may be recollected each time the same or a slightly different variation on the same problem occurs. Sifting and collating problem reports to reduce them to a more manageable number is a daunting task. Adding problem reports as the information is being sifted further exacerbates this problem. Furthermore, technology is changing so rapidly today that problem codes may be directed at stale problems or obsolete solutions. Consequently, customer service organizations expend considerable energy and company resources collecting and maintaining adequate problem report documentation.

Thus, there is a need for improved methods of keeping CSRs up to date and that facilitates quickly reporting specific solutions to product problems.

### SUMMARY OF THE INVENTION

It is a purpose of the invention to improve product support;

It is another purpose of the invention to reduce customer service time and effort expended in collecting product problem data;

It is yet another purpose of the invention to provide specific and up to date descriptions of program product problem resolutions.

The present invention relates to a product service reporting system, method and program product for reporting product problem resolutions. A service code database contains service code records of previously encountered product problem and associated problem solutions. The service code database is sorted based on service code. Problems and associated problem solutions for specific products are entered in the service code database thorough a service code input interface. Service code records are hierarchically searched by field through a customer service input interface.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a preferred embodiment product service reporting system; and

FIG. 2 shows an example of hierarchically searching service code records to find and return an appropriate service code.

### DESCRIPTION OF PREFERRED EMBODIMENTS

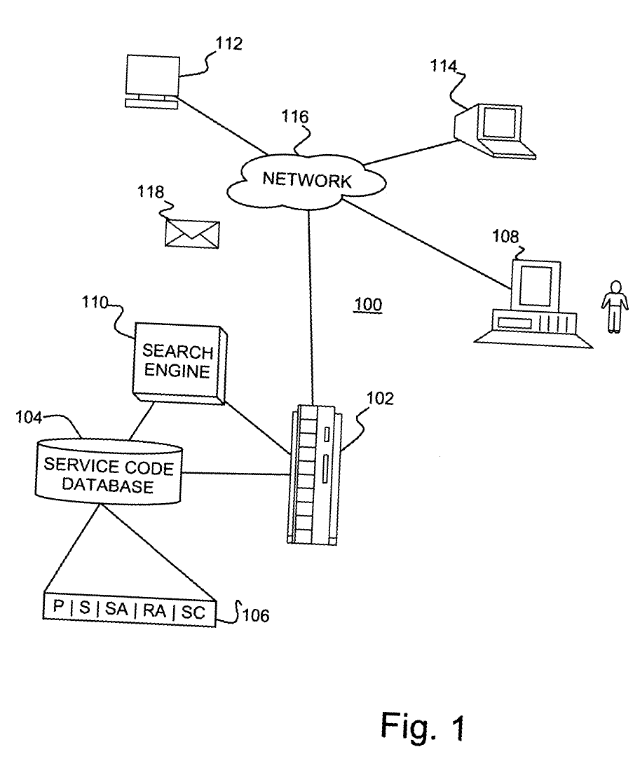

FIG. 1 shows an example of a product service reporting system 100 according to a preferred embodiment of the present invention. In particular, the product service reporting system 100 may provide customer service support for reporting solutions to problems for any typical system, subsystem and subassembly, such as an IBM 3494 Tape Library Dataserver (IBM 3494). The product service reporting system 100 may include a service appliance, server (102 in this example) or service communications tool that may be centrally located or distributed amongst a number of remotely connected devices. A service code database 104 located on the server 102, for example, stores service code records 106 of solutions to previously encountered product problems. Service code records 106 may be generated through a service code GUI that may be available at a product management terminal 108 located with the server 102, or remotely located, e.g., at a customer service office. Each service code record 106 may include, for example, Product identification (P), Subsystem identification (S), Subassembly identification (SA), Repair Action (RA) and an associated Service Code (SC). A search engine 110 may be included to facilitate quickly searching hierarchically through the service code database 104. Remotely located customer service terminals 112 include a graphical user interface (GUI) to provide Customer Service Representatives (CSRs) with access to the product service reporting system 100. Optionally, one or more customer service units (CSU) 114 are available for customer access to the product service reporting system 100. In this example, the product management terminal 108, customer service terminals 112 and customer service units 114 are connected to the product service reporting system 100 over a network such as the Internet 116. Also, a manufacturer update facility (e.g., an automatic e-mail generation facility) 118 may be provided to notify the customer service organization, for example, of newly added or modified service code records 106.

So, a user (a customer or a CSR) can enter problem reports through one of the customer service terminals 112 or customer service units 114. Then, the user hierarchically searches the service code database 104 (e.g., using search engine 110) to select a record that specifically matches the problem how it was resolved. Preferably, the service code records 106 are sorted in ascending alphabetic order by field for quicker searching. Each service code record 106 may include a problem repair action (RA) of any length and detail. The repair action may be remotely updated (e.g., from the product management terminal 108) to improve problem isolation to a specific problem set. Further, service code database 104 updates may be distributed, e.g., e-mailed 118, and service codes may be returned (also e-mailed 118) as a service event.

Thus, it may be determined through data mining or otherwise that one service code is associated with a high number of reported part or non-parts activity requests on a given machine area. For example, an unusually high number of adjustments are being required to the accessor assembly in a mass storage system. This may indicate that that particular service code is too generic to provide problem tracking with sufficient specificity and that the service code covers a number of different related/unrelated problems. In response, the list of service codes or service code records 106 may be dynamically updated, interactively asking service personnel additional questions on the specific service action in real time to elicit responses that improve problem isolation. Thereafter, service codes may be quickly and automatically updated in all service appliances or servers worldwide, e.g., at local copies of the service code database 110. Thus, instead of relying on very limited information in QSAR data with multiple follow-up calls to service personnel (sometimes occurring weeks or months later) to obtain information with necessary specificity; the preferred embodiment product service reporting system 100 collects very specific and timely data seamlessly and nearly automatically.

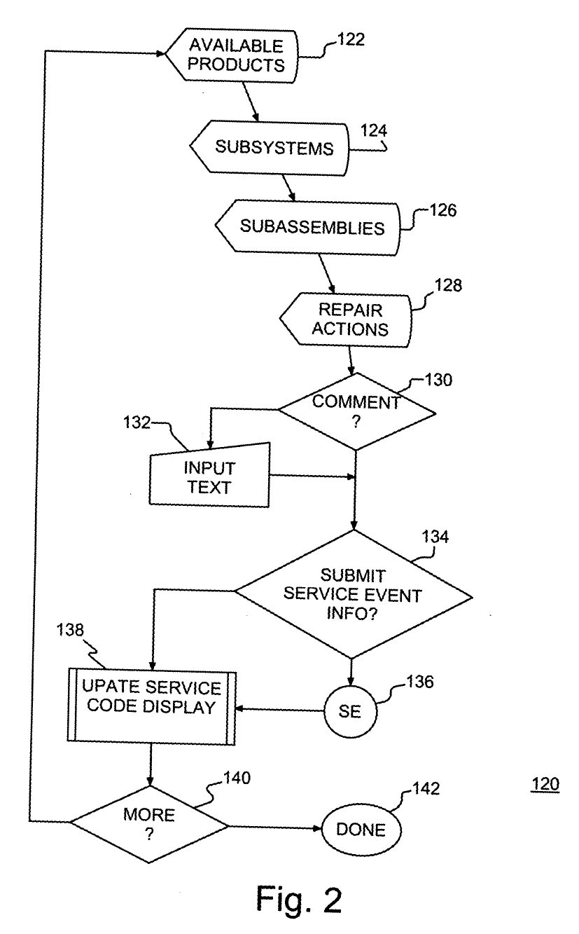

FIG. 2 shows an example of hierarchically searching 120 service code records (106 in FIG. 1) to find and return an appropriate service code according to a preferred embodiment of the present invention. First, in step 122 all unique product names are displayed (e.g., at a CSU 114) and one product is selected. Then, in step 124 a list of unique subsystem names are displayed for the selected product and one subsystem is selected. In step 126 all unique subassemblies are displayed for the selected subsystem, and one subassembly is selected. Next, in step 128, list of recognized repair actions for the selected subassembly are displayed and one repair action is selected. A service code is generated as a result of selecting a specific repair action, and if desired in step 130, comments 132 may be added to the service code describing the service performed. Once comments have been added in step 132 or if in step 130 it is decided not to enter comments, in step 134 the selected information may be submitted as a service event 136. Once the service event is submitted in step 136 or canceled in step 134, in step 138 the service code data may be updated automatically on the service appliance or server 102 using any suitable method. Then, in step 140 if additional problem solutions remain to be reported, returning to step 122 another/the same product may be selected and another appropriate service code generated. Once all problems have been addressed in step 140, the search is complete 142.

Thus, advantageously, instead of relying on very limited information in QSAR data or being plagued with multiple costly follow up calls to service personnel to obtain service information; the preferred embodiment product service reporting system 100 collects timely service data and, seamlessly and nearly automatically, provides service personnel with specifically tailored and descriptive service codes. The preferred embodiment product service reporting system minimizes or nearly eliminates field reporting delays and especially expensive follow up calls that previously occurred only well after the problem details have been forgotten. Since the CSR can enter the data and update service codes on the fly and in real time in a preferred embodiment system, database updates take place immediately rather than weeks or months after the problem. In a further advantage of the present invention, the service code activity may be monitored and service codes updated in response to elicit more specific feedback information from the field. Thus, persistent problems can be isolated and eliminated. Coincidentally, service information can be synchronized for all connected machines, worldwide and the collected information may be seamlessly and automatically returned to the customer service organization.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A method of error reporting, said method comprising the steps of:
a) selecting a product from a displayed group of available products;
b) selecting a subsystem from a displayed group of available subsystems within a selected said product;
c) selecting a subassembly from a displayed group of available subassemblies within a selected said subsystem; and
d) selecting a repair action from a displayed group of repair actions previously applied to said selected subassembly.

2. A method as in claim 1, further comprising the step of:
e) entering comments associated with a selected said repair action.

3. A method as in claim 2, further comprising the step of:
f) updating a service code record for said selected said repair action.

4. A method as in claim 3, wherein service code records are maintained in a service code database, and the step (a) of selecting a product comprises the steps of:
i) retrieving ones of said service code records from said service code database; and
ii) displaying retrieved said service code records, said product being selected in step (a) from said retrieved service code records.

5. A method as in claim 4, wherein said service code records include fields for product identification, subsystem identification, subassembly identification, repair action and an associated service code.

6. A method as in claim 5, further comprising hierarchically sorting said service code records according to included said fields.

7. A method as in claim 6, wherein said service code records are hierarchically sorted before to step (a) of selecting said product.

8. A method as in claim 3, further comprising the steps of:
g) selectively submitting a service event for the updated said service code.

9. A computer program product for providing customer service support, said computer program product comprising a computer usable medium having computer readable program code thereon, said computer readable program code comprising:
computer readable program code means for maintaining a service code database containing service code records of previously encountered problems with said specific problems;
computer readable program code means for searching said service code database for a corresponding previously encountered problem responsive to a problem request; and
computer readable program code means for entering and updating said service code records.

10. A computer program product for providing customer service support as in claim 9, further comprising:
computer readable program means for sorting said service code records in said service code database.

11. A computer program product for providing customer service support as in claim 10, wherein said service code records include fields for product identification, subsystem identification, subassembly identification, repair action and an associated service code.

12. A computer program product for providing customer service support as in claim 11, wherein said computer readable program code means for sorting sorts said service code records hierarchically, first on product identification, next on subsystem identification, then on subassembly identification, and finally on repair action.

13. A computer program product for providing customer service support as in claim 12, further comprising:
computer readable program code means for submitting a service event for an associated said product.

14. A customer service system comprising:
a customer service input interface, product problem reports being entered through said customer service input interface, each said product problem being associated with a specific product;
a service code database containing service code records of previously encountered product problems and corresponding solutions;
a service code input interface service code records being entered and updated in said service code database through said service code input interface; and
a search engine searching said service code database for a corresponding previously encountered problem responsive to a problem request entered in said customer service input interface.

15. A customer service system as in claim 14, wherein said service code records include fields for product identification, subsystem identification, subassembly identification, repair action and an associated service code

16. A customer service system as in claim 14, wherein said service code records are sorted in said service code database according to said fields, first on product identification, next on subsystem identification, then on subassembly identification, and finally on repair action.

17. A customer service system as in claim 16, wherein said search engine searches said service code records hierarchically on said fields.

18. A customer service system as in claim 17, further comprising:
a service event generator selectively generating a service event for ones of said products.

19. A customer service system as in claim 18, wherein said service event generator comprises an e-mail facility.
